(19) United States
(12) Patent Application Publication
(10) Pub. No.: US 2023/0300120 A1
(43) Pub. Date: Sep. 21, 2023

(54) SYSTEM AND METHOD FOR LATTICE-BASED CRYPTOGRAPHY

(71) Applicant: The United States of America, as represented by the Secretary of the Navy, Crane, IN (US)

(72) Inventors: Benny N. Cheng, Chino Hills, CA (US); Aaron Fogel, Corona, CA (US); Peter Schaedler, Anaheim, CA (US)

(73) Assignee: The United States of America, as represented by the Secretary of the Navy, Arlington, VA (US)

(21) Appl. No.: 17/982,816

(22) Filed: Nov. 8, 2022

Related U.S. Application Data
(60) Provisional application No. 63/319,892, filed on Mar. 15, 2022.

(51) Int. Cl. H04L 9/40; H04L 9/30; H04L 9/08; H04L 9/06

(52) U.S. Cl. CPC H04L 63/045; H04L 9/3073; H04L 9/0869; H04L 9/0631

(57) ABSTRACT

Systems and methods for lattice-based cryptography in accordance with embodiments of the invention are described. A process for sending a secure encrypted message includes obtaining, by a first device, a public key of a public key/private key pair, encrypting, by the first device, unencrypted payload data using a symmetric encryption key in a symmetric encryption operation, encrypting, by the first device, the symmetric encryption key using the public key of the message recipient in an asymmetric encryption operation, sending, by the first device, the encrypted payload data and the encrypted symmetric encryption key to a second device, receiving, by the second device, the encrypted payload data and the encrypted symmetric key, decrypting, by the second device, the encrypted symmetric key using a private key to recover the symmetric key, and decrypting, by the second device, the encrypted payload data using the symmetric key to recover the unencrypted payload data.

### CROSS REFERENCE TO RELATED APPLICATIONS

This application claims priority under 35 U.S.C. § 119(e) of U.S. provisional patent application Ser. No. 63/319,892 filed on Mar. 15, 2022 entitled “SYSTEM AND METHOD FOR LATTICE-BASED CRYPTOGRAPHY,” the disclosure of which is hereby incorporated herein by reference.

### STATEMENT REGARDING FEDERALLY SPONSORED RESEARCH OR DEVELOPMENT

The invention described herein includes contributions by one or more employees of the Department of the Navy made in performance of official duties and may be manufactured, used and licensed by or for the United States Government for any governmental purpose without payment of any royalties thereon. This invention (Navy Case 210142US02) is assigned to the United States Government and is available for licensing for commercial purposes. Licensing and technical inquiries may be directed to the Technology Transfer Office, Naval Surface Warfare Center, Corona Division, email: CRNA_CTO@navy.mil.

### FIELD

The present disclosure relates generally to cryptographically protecting electronic messages and more specifically to lattice-based cryptographic encryption.

### BACKGROUND

The imminence of quantum computing creates a race for new cryptography standards that can withstand the new computing paradigm and replace current standards that can be rendered obsolete. With the passage of time and the rapid development of quantum technology, it is predicted that within a decade or so, a sufficiently powerful quantum computer could be developed that can render all public key cryptosystems obsolete. It has been demonstrated that existing widely used public-key schemes for encrypting data (RSA, Diffie-Hellman, elliptic curve, etc.) are no longer secure against the computing power of quantum computers. One leading contender being explored that is resistant to attack by classical and quantum computers is lattice-based cryptography. Lattice-based cryptography operates under the premise that there are no polynomial time algorithms, either classical or quantum, that can solve the Shortest Vector Problem (SVP); that is, finding the shortest (non-zero) vector given a lattice.

### SUMMARY

Systems and methods for lattice-based encryption and decryption of electronic messages are disclosed. In one embodiment, a process for sending a secure encrypted message from a first computing device to a second computing device includes obtaining, by the first device, a public key of a public key/private key pair associated with a message recipient, encrypting, by the first device, unencrypted payload data to generate encrypted payload data using a symmetric encryption key in a symmetric encryption operation, encrypting, by the first device, the symmetric encryption key using the public key of the message recipient in an asymmetric encryption operation, sending, by the first device, the encrypted payload data and the encrypted symmetric encryption key to the second device, receiving, by the second device, the encrypted payload data and the encrypted symmetric key, decrypting, by the second device, the encrypted symmetric key using a private key of the public key/private key pair associated with the message recipient to recover the symmetric key, and decrypting, by the second device, the encrypted payload data using the symmetric key to recover the unencrypted payload data.

Another embodiment also includes capturing user input on the first computing device and using the user input as the unencrypted payload data.

A further embodiment also includes generating the private key-public key pair for the second computing device.

In yet another embodiment, the asymmetric encryption operation utilizes NTRU (nth degree truncated polynomial ring) encryption protocol.

In a further embodiment again, the symmetric encryption operation utilizes AES256-GCM encryption protocol.

A yet further embodiment also includes encrypting at least a portion of the unencrypted payload data using a public key of the public key/private key pair associated with the message recipient to generate an electronic signature of the encrypted payload data for authentication.

In another embodiment, encrypting, by the first device, the symmetric encryption key using the public key of the message recipient in an asymmetric encryption operation further comprises encrypting an initiation vector (IV) used in connection with the symmetric encryption key.

In a further embodiment, the encrypted payload data and the encrypted symmetric encryption key are sent to the second device separately.

Yet another embodiment also includes repeating the encrypting and decrypting multiple sets of payload data, and combining, by the second device, the multiple sets of payload data after decryption into a single message.

In a further embodiment, the symmetric encryption operation and asymmetric encryption operation are calls to a JavaScript library.

In yet another embodiment, the asymmetric encryption operation utilizes NTRU (nth degree truncated polynomial ring) encryption protocol modified by adding a random constant to all generated random bytes, where the random constant is generated with each invocation of a random bytes generator.

In a further embodiment again, the asymmetric encryption operation utilizes NTRU (nth degree truncated polynomial ring) encryption protocol modified by increasing the sizes of the public key and private key.

In a yet further embodiment, the JavaScript library is packaged in a docker container.

In another embodiment, instructions within the docker container instructs the first device to install Linux in a virtual environment and compile source code of the asymmetric encryption operation into JavaScript.

In a further embodiment, the JavaScript library is stored into a shared file directory that is shared between the docker container and the host system of the first device.

### BRIEF DESCRIPTION OF THE DRAWINGS

FIG. 1 conceptually illustrates a computing system in accordance with several embodiments of the invention.

FIG. 2 conceptually illustrates a server system in accordance with several embodiments of the invention.

FIG. 3 conceptually illustrates a client system in accordance with several embodiments of the invention.

FIGS. 4A and 4B illustrate a process for encrypting and decrypting a message using a hybrid encryption scheme in accordance with several embodiments of the invention.

FIG. 5 illustrates a process for sending and receiving encrypted messages in accordance with several embodiments of the invention.

FIG. 6 illustrates instructions within a docker container file in accordance with several embodiments of the invention.

### DETAILED DESCRIPTION

Turning now to the drawings, systems and methods for lattice-based cryptography in accordance with embodiments of the invention are described. As mentioned above, newer lattice-based cryptography schemes can be more resistant to advances in computing power. One such lattice-based public-key system is NTRU (nth degree truncated polynomial ring). While NTRU is more secure, it is magnitudes slower than a symmetric cipher such as AES. Therefore, there are some limitations to its use and implementation.

Many embodiments of the invention implement any or all of three components to allow full incorporation of a lattice-based cryptosystem into an application: a hybrid symmetric and asymmetric encryption protocol, a library as a code wrapper (e.g., JavaScript) for interoperability, and a docker container for portability and updates. In further embodiments of the invention, the hybrid encryption protocol utilizes NTRU that is modified from its default mode of operation for additional security and operability.

Computing Systems for Cryptographic Operations

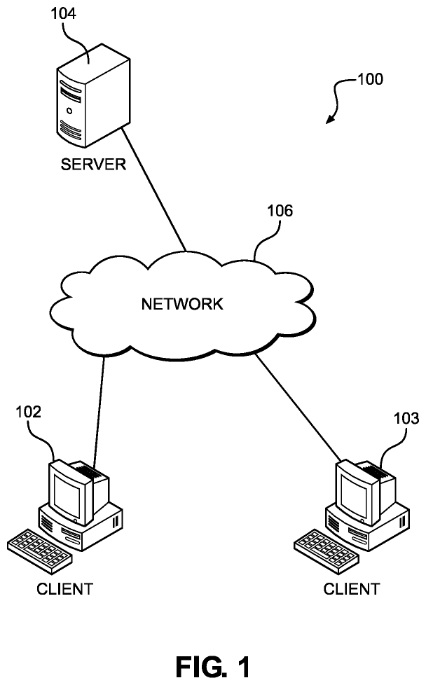

Several embodiments of the invention may be implemented in a networked computing system having a client and server that interact, such as the one conceptually illustrated in FIG. 1. The system 100 includes one or more clients 102 and 103 and a server 104 that can communicate over a network 106. In some embodiments, client 102 is a sender system that sends a secure message to a client 103 that is a receiver system. In other embodiments, client 102 is a sender system that sends a secure message to server 104 that is a receiver system. As will be discussed further below, processes can be performed on client 102 and/or server 104 to encrypt and/or decrypt messages.

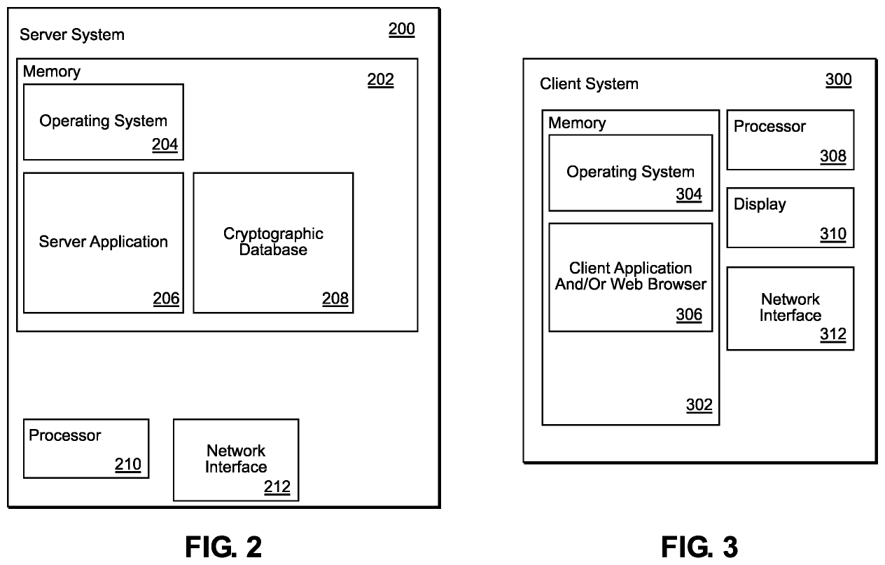

A conceptual diagram of a server system 200 in accordance with an embodiment of the invention is conceptually illustrated in FIG. 2. The server system 200 includes memory 202 having an operating system 204, a server application 206, and a cryptographic database 208. The server system 200 also includes a processor 210 and network interface 212.

A conceptual diagram of a client system 300 in accordance with an embodiment of the invention is conceptually illustrated in FIG. 3. The client system 300 includes memory 302 having an operating system 304 and a client application 306. The client application 306 may be a web browser. It also includes a processor 308, a display 310, and a network interface 312.

In some embodiments, the server system is a web server that can provide clients using a web browser with a graphical user interface within a web page. The client system can receive and display the web page. In other embodiments, the client system includes a client application that can configure a display to present a graphical user interface. The client system can receive information from the server system for what to display within a graphical user interface and can provide captured information back to the server system.

Although specific architectures are discussed above with respect to FIGS. 1-3, one skilled in the art will recognize that any of a variety of computing systems may be utilized in accordance with embodiments of the invention. Encryption schemes are discussed next.

Hybrid Encryption Scheme

As mentioned above, many embodiments of the invention utilize a hybrid encryption scheme that combines a symmetric protocol with an asymmetric protocol. Several embodiments utilize AES256-GCM as a symmetric protocol and NTRU as an asymmetric protocol. Operations such as key generation, encryption, and decryption may be performed using JavaScript code such as described further below or other available cryptographic libraries.

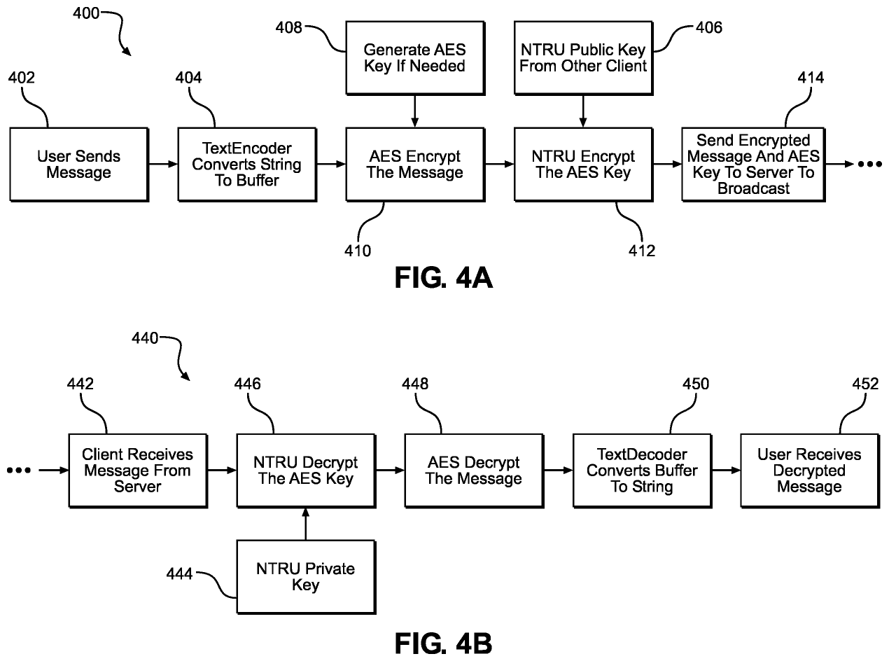

However, the NTRU algorithm by itself is typically not efficient for large data encryption applications as it is relatively slow compared to other classical non-quantum safe schemes. Several embodiments of the invention provide a more efficient and much faster hybrid encryption scheme that incorporates the AES256-GCM symmetric encryption for data encryption with the smaller keys encrypted with NTRU. A process 400 for sending an encrypted message using a hybrid scheme in accordance with an embodiment of the invention is illustrated in FIG. 4A.

The first system, a sender system (such as client 102 in FIG. 1), obtains (402) a message that is to be sent to the second system, a receiver system (such as client 103 in FIG. 1). The message (e.g., provided in plaint text or other human-readable format) can be first converted (404) to a byte array (e.g., Uint8Array), or another suitable format, as a standard format to communicate data. In some embodiments, the message can be entered into a user interface by a user and captured by the sender system.

The second system (the receiver system, such as client 103 in FIG. 1) has a public-key/private-key pair in an asymmetric encryption scheme, such as NTRU, or generates such a pair if it does not. The receiver system sends (406) its public key to the sender system, which does not have to occur over a secure channel. It keeps the private key securely without disclosing publicly, as is typical with asymmetric encryption.

The sender system has a symmetric key according to a symmetric encryption scheme, such as AES (Advanced Encryption Standard), or generates (408) one if it does not. Several embodiments of the invention utilize AES256-GCM. Timing tests were performed on different versions of AES, and AES256-GCM has enough speed while having an authenticated encryption mode for confidentiality.

The sender system encrypts (410) the message to be sent using the symmetric key. If the message is too long, it can be split and recombined at the receiver. Encrypting with a symmetric encryption algorithm like AES is faster and allows for larger messages than using an asymmetric algorithm. AES256-GCM is also considered a quantum-resistant encryption algorithm. The symmetric key should not initially be known to entities other than the sender system.

The sender system encrypts (412) the symmetric key using the receiver's public key (e.g., the public NTRU key). In additional embodiments of the invention, a portion of the message (e.g., first several bytes) is also encrypted together with the symmetric key. This can serve as a type of authentication. When the receiver decrypts the portion of the message encrypted with the symmetric key, it can compare it with the original message decrypted using the private key to check that they are identical.

In further embodiments of the invention, the initiation vector (IV) used in connection with the symmetric key can be concatenated with the symmetric key and encrypted together.

The encrypted message and encrypted symmetric key are sent (414) to the receiver system. In some embodiments, the encrypted packages are sent together. In other embodiments, the encrypted packages are sent separately (e.g., over separate channels).

A process 440 for receiving and decrypting an encrypted message using a hybrid scheme in accordance with an embodiment of the invention is illustrated in FIG. 4B.

The receiver system receives (442) the encrypted message and encrypted symmetric key. If the receiver system does not already have the receiver's private key (e.g., private NTRU key), it obtains (444) the key. The receiver system decrypts (446) the encrypted symmetric key to recover the symmetric key. Using the symmetric key, the receiver system decrypts (448) the encrypted message to recover the original message. If the encrypted message was split for excess length, the portions of the message are recombined. The message can be converted (450) to text or whichever human-readable format it was in originally and provided (452) to the recipient user.

Although specific processes are discussed above with respect to FIGS. 4A and 4B, one skilled in the art will recognize that any of a variety of processes may be utilized in accordance with embodiments of the invention.

Sending and Receiving Encrypted Messages

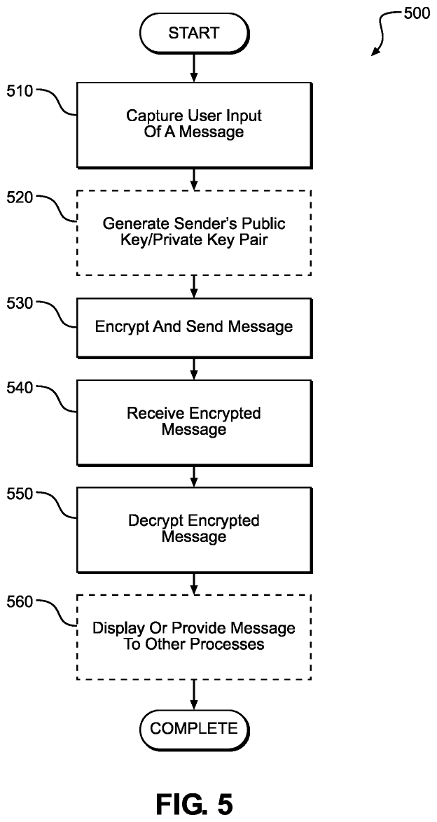

Devices such as client systems described above can be used by users who wish to send and receive encrypted messages that implement a hybrid encryption scheme. A process 500 for sending and receiving encrypted messages in accordance with embodiments of the invention is illustrated in FIG. 5.

The process 500 includes capturing (510) user input of a message from a sending user on a sending device. The message can be captured on any of a variety of mechanisms, such as a keyboard or touch screen, and may be captured, for example, within a web browser. Additional user input can also indicate whether to create (520) a private key, e.g., if the sending user does not yet have one. Similarly, the receiving user may have a private key created. A private key can be generated using, for example, a code library such as a keygen function discussed further below.

At 530, the process 500 includes using the captured user input to encrypt and send the message. The message is encrypted (530) using the receiver's public key and a symmetric key using a hybrid encryption scheme such as those described above with respect to FIG. 4A. The sent encrypted message is received by a receiving device (540), for example, over a network.

A receiving device decrypts (550) the message using the receiver's private key. In many embodiments of the invention, the receiving device utilizes a hybrid encryption scheme where it first decrypts and recovers the symmetric key with its private key and then decrypts the message with the symmetric key. Some such processes are described above with respect to FIG. 4B. The message can then be displayed (560) or provided to another process for use by the receiver.

Although a specific process is described above with respect to FIG. 5, one skilled in the art will recognize that any of a variety of processes may be utilized for sending encrypted messages in accordance with embodiments of the invention. Operations such as key generation, encryption, and decryption may be performed using JavaScript code such as described further below or other available cryptographic libraries.

Code Libraries

Many embodiments of the invention can utilize a JavaScript wrapper to integrate a hybrid encryption scheme, such as those described above, into specific applications such as, for example, a web page. The libraries can provide key functions such as creating keys and encrypting and decrypting messages/payloads. Some embodiments may utilize a C-code package for NTRU, in particular libsodium.

Several embodiments of the invention can be based on a reference library such as the open reference implementation NTRU.js (available at https://github.com.cyph/ntru.js/, the relevant portions of which are incorporated by reference). The NTRU.js JavaScript library is publicly available and compiled using Emscripten into WebAssembly that can be used in any web-based client-server application.

In many embodiments of the invention, one or more changes are made to the reference (i.e., standard or default) implementation of NTRU to increase robustness of the encryption scheme. First, there can be an adjustment to how random bytes used to generate parameters are seeded. Usually, in reference implementations, the base operating system of the encrypting (sending) device provides a random number for the seed. In several embodiments, the hybrid encryption scheme can ensure enough entropy in the seed by adding a random constant to all generated random bytes for further obfuscation of the random number generation. In further embodiments, a new constant can be generated with each invocation of the random bytes generator.

Second, the NTRU parameter set can be changed from the default values to different values (e.g., one or more security parameters such as the size of the key generated). One such parameter can be the public key size. Default settings utilize 128-bit security (keys) as the lowest level. Several embodiments set the key size for the highest available military strength size. For example, an option of the NTRU library is an EES743EP1 parameter set, which is seen as equivalent (as strong as) to 256-bit symmetric RSA cypher, where the key size is longer.

Some embodiments include both of the changes described above.

Example usage of NTRU.js function calls in accordance with some embodiments of the invention is listed below:

<script src=“ntru.js”></script>
(async) ntru.encrypt(Uint8Array data, Uint8Array publicKey)

The function above encrypts payload data with the given NTRU public key. In some embodiments, the payload data must be less than or equal to 106 bytes. (async) ntru.decrypt(Uint8Array data, Uint8Array privateKey)

The function above decrypts data with the given NTRU private key. In some embodiments, the data must be 1022 bytes.

In many embodiments, the AES components can be implemented using Web Crypto libraries (available at https://developer.mozilla.org/en-US/docs/Web/API/Web_Crypto_API, the relevant portions of which are incorporated by reference).

Example usage of Web Crypto function calls in accordance with some embodiments of the invention are listed below:

(async) crypto.subtle.importKey(‘raw’, Uint8Array key,
‘AES-GCM’, true, [‘encrypt’, ‘decrypt’])

The function above converts an AES key supplied as a byte array to the format needed for Web Crypto.

crypto.getRandomValues(Uint8Array array)

The function above fills the given array with random bytes. For the initialization vector (IV) needed, the array should 12 bytes in length.

```
(async) crypto.subtle.encrypt(
  {
    name: ‘AES-GCM’,
    iv: Uint8Array initialization_vector
  },
  AESKey key,
  Uint8Array data)
```

The function above encrypts data using AES-256-GCM. Provided as input are an initialization vector (random bytes) of length 12 bytes, an AES key in the Web Crypto format (see importKey above), and data. Data is returned in a special format. To get the data as a byte array, initialize a new Uint8Array using the result. For example, ciphertext=new Uint8Array(encrypted);

In order to decrypt the message, the IV can also be used. When communicating the encrypted message, the IV can be concatenated to the beginning or end of the encrypted data, then split off on the receiving side.

```
(async) crypto.subtle.decrypt(
  {
    name: ‘AES-GCM’,
    iv: Uint8Array initialization_vector
  },
  AESKey key,
  Uint8Array encrypted_data)
```

The function above decrypts data using AES-256-GCM. It takes as input the same initialization vector (IV) used when encrypting, as well as the AES key and encrypted data.

Additional details on encrypt and decrypt operations are provided in the sections further below. In different embodiments of the invention, the execution of the libraries can be performed on the client device (generally slower) or on the server (generally faster). Implementation on the client device using, for example Web Crypto, can relieve memory storage issues on the server, with resulting speeds attainable during testing of around 600-700 MB/s. The client-side library can use the SubtleCrypto API (available at https://developer.mozilla.org/en-US/docs/Web/API/SubtleCrypto) built into modern web browsers, which provides random number generation and AES implementation. The server-side library can use @peculiar/webcrypto (available at https://github.com/PeculiarVentures/webcrypto), a package that provides a similar interface as SubtleCrypto. Another server-side library can use libsodium (sodium-native JavaScript wrapper), which has XChaCha20-Polyl305 as a replacement for AES256-GCM.

Next are described keygen, encrypt, and decrypt operations in accordance with several embodiments of the invention.

Keygen

The keygen (key generation) function takes no parameters and returns a JavaScript object containing a public key and a private key, both as byte arrays (Uint8Array type). This is only for the NTRU keys, because the recipient's public key is communicated to the sender before encryption. The function itself uses the NTRU library's function to generate a key pair. The keygen function may be utilized, for example, in 520 of process 500 and to generate NTRU keys in processes 400 and 440 discussed further above.

Pseudocode for a keygen function that generates and returns a key pair can be expressed as follows:
function keygen( ):
generate NTRU key pair
return the key pair

Encrypt

The encrypt function takes an NTRU public key and data, both as byte arrays (Uint8Array type). The encrypt function can be utilized to encrypt a payload data, such as a symmetric key in 412 of process 400 and in 530 of process 500 discussed further above.

First, an AES key can be generated, and then a 12-byte random initialization vector (IV) can be generated, if not already present. The IV is used to guarantee a different encrypted result even when using the same data and same key, and does not need to be kept secret. However, a different IV should be used for each instance of encryption. In this case, both the IV and key are generated for each invocation.

The data is then encrypted with AES256-GCM using the IV and AES key. Then for type compatibility, the AES key and encrypted data are converted from their object formats to byte arrays.

Next, the AES key is encrypted using the NTRU public key. Finally, the IV and encrypted key are concatenated together, then that is concatenated with the encrypted data, and the full byte array is returned. So the full encrypted package is in the form:
IV (12 bytes) | Enc. AES key (1022 bytes) | Enc. Data (variable length)

This process is similar for the XChaCha20 library. A ChaCha key and a nonce (random string of 24 bytes) are generated. The nonce plays the same role as the IV for AES. Then, buffers are created and allocated for the data and the encrypted data. The encrypted buffer contains space for the message and a MAC (message authentication code) generated by the encryption process. The data is encrypted with ChaCha using the key and nonce. The necessary pieces are converted to Uint8Arrays, the key is NTRU encrypted with the public key, and everything is concatenated together.

Pseudocode for an encrypt function, which includes generating a symmetric key and encrypting data, can be expressed as follows:
function encrypt(public key, data):
   generate symmetric encryption key (AES/ChaCha)
   generate random bytes (IV/nonce)
   encrypt data with symmetric encryption using IV/nonce
   encrypt symmetric key with NTRU public key
   concatenate data together in the form (IV, encrypted symmetric key, encrypted data)
   return concatenated package

Decrypt

The decrypt function takes an NTRU private key and an encrypted data package, created using the encrypt function, both as byte arrays (Uint8Array type).

First, the encrypted data package is split into separate pieces for the IV, encrypted AES key, and encrypted data. Then the AES key is decrypted using the NTRU private key into a byte array. The key is converted to its object format required by the AES library, and is then used along with the IV to decrypt the message data, which is then returned as a byte array.

This process is again similar for the ChaCha library. The data package is split into pieces. Then the ChaCha key is decrypted using the NTRU private key. Once everything is converted into a Buffer type and a buffer is allocated for the decrypted data, the data is decrypted using ChaCha with the key and the nonce. Finally, the decrypted data is returned as a byte array.

Pseudocode for a decrypt function, which includes recovering data from an encrypted data package, can be expressed as follows:
function decrypt(private key, data package):
   split data package into IV/nonce, encrypted symmetric key, and encrypted data
   decrypt symmetric key with NTRU private key
   decrypt data with symmetric decryption using IV/nonce
   return decrypted data

Docker Containers

In many embodiments of the invention, the code libraries are packaged into docker containers. A docker container can provide a means to easily compile any changes made to the base NTRU implementation (written in C) into updated JavaScript code in a platform-agnostic way. That is to say, it allows pushing updates to WebNTRU to any computer without having to consider the packages and operating system on the computer in question.

The basic component of a Docker container is a DockerFile. The DockerFile is a set of instruction for the Docker application to create the Docker container, which is a custom virtual environment to be worked within. For several embodiments of the invention, the virtual environment is an instance of Debian Linux. This allows the use of the tool Emscripten to compile the C code into JavaScript (Emscripten is very particular and does not work well in Windows, and even some types of Linux as well).

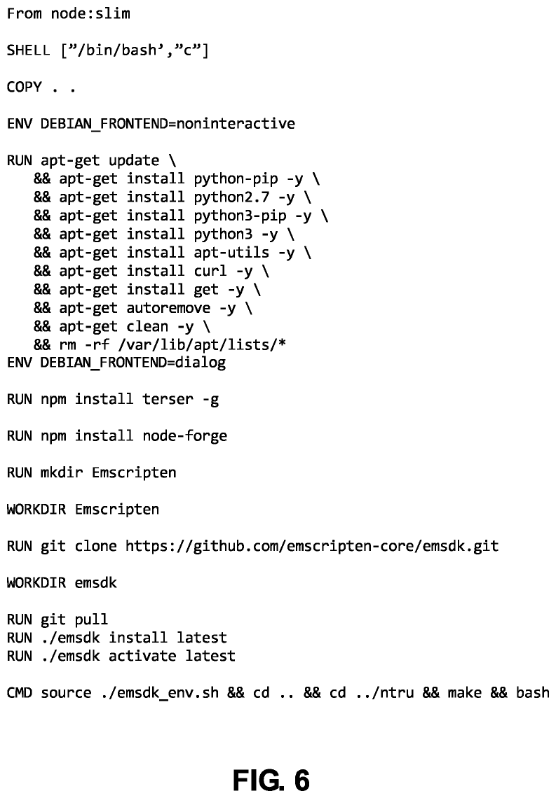

The contents of a WebNTRU DockerFile in accordance with some embodiments of the invention are illustrated in FIG. 6. The contents of the DockerFile instruct the computer to perform the following:

Download a stripped-down version of Debian Linux with node JS installed from the official Docker repositories, and create a virtual environment/container running the instance of Debian.

Create a user-interactable shell in the virtual environment/container (bash).

Set the Debian environment to not bring up prompts for user input (makes initial setup smoother).

Download and install all the packages that needed for compilation (except Emscripten, the compilation tool itself).

Download some packages from npm as well—notable terser (for Emscripten and compilation) and node-forge (for AES encryption).

Create a directory for Emscripten and clone the tool from Git.

Install and activate Emscripten.

The final command is what is run in the container's shell on startup—the command sets environment variables so Emscripten can run smoothly in the filesystem of the container, navigates to the folder container the ntru.js source code, and runs the MakeFile to compile a new version of ntru.js. The command then opens the shell of the container for the user to interact with if necessary.

Inside the documentation for the DockerFile are the commands to run in terminal to create and run the container, including a command that sets up a shared file directory between the host computer and the container itself (being a virtual environment, the container by default has its own filesystem that is separate from the host's). This streamlines the compilation process wherein the container runs, compiles the code in the shared directory, and exits, thereby leaving the compiled ntru.js code in the same shared directory for the host computer to access. Although a specific process is described above, one skilled in the art will recognize that variations are possible. For example, other distributions of Linux and other code libraries with similar functionality may be utilized.

### CONCLUSION

Although the description above contains many specificities, these should not be construed as limiting the scope of the invention but as merely providing illustrations of some of the presently preferred embodiments of the invention. Various other embodiments are possible within its scope. Accordingly, the scope of the invention should be determined not by the embodiments illustrated, but by the appended claims and their equivalents.

What is claimed is:

1. A method for sending a secure encrypted message from a first computing device to a second computing device, the method comprising:
obtaining, by the first device, a public key of a public key/private key pair associated with a message recipient;
encrypting, by the first device, unencrypted payload data to generate encrypted payload data using a symmetric encryption key in a symmetric encryption operation;
encrypting, by the first device, the symmetric encryption key using the public key of the message recipient in an asymmetric encryption operation using NTRU (nth degree truncated polynomial ring) encryption protocol;
sending, by the first device, the encrypted payload data and the encrypted symmetric encryption key to the second device;
receiving, by the second device, the encrypted payload data and the encrypted symmetric key;
decrypting, by the second device, the encrypted symmetric key using a private key of the public key/private key pair associated with the message recipient to recover the symmetric key; and
decrypting, by the second device, the encrypted payload data using the symmetric key to recover the unencrypted payload data.

2. The method of claim 1, wherein the NTRU encryption protocol is modified to add a random constant number to all generated random bytes.

3. The method of claim 1, wherein the NTRU encryption protocol is modified to have a different key size from the default size.

4. The method of claim 3, wherein the NTRU encryption protocol is implemented with an EES743EP1 parameter set for key size.

5. The method of claim 1, further comprising capturing user input on the first computing device and using the user input as the unencrypted payload data.

6. The method of claim 1, further comprising generating the private key-public key pair for the second computing device.

7. The method of claim 1, wherein the symmetric encryption operation utilizes AES256-GCM encryption protocol.

8. The method of claim 1, further comprising encrypting at least a portion of the unencrypted payload data using a public key of the public key/private key pair associated with the message recipient to generate an electronic signature of the encrypted payload data for authentication.

9. The method of claim 1, wherein encrypting, by the first device, the symmetric encryption key using the public key of the message recipient in an asymmetric encryption operation further comprises encrypting an initiation vector (IV) used in connection with the symmetric encryption key.

10. The method of claim 1, wherein the encrypted payload data and the encrypted symmetric encryption key are sent to the second device separately.

11. The method of claim 1, further comprising repeating the encrypting and decrypting multiple sets of payload data, and combining, by the second device, the multiple sets of payload data after decryption into a single message.

12. The method of claim 1, wherein the symmetric encryption operation and asymmetric encryption operation are calls to a JavaScript library.

13. The method of claim 12, wherein the asymmetric encryption operation utilizes the NTRU (nth degree truncated polynomial ring) encryption protocol modified by adding a random constant to all generated random bytes, where the random constant is generated with each invocation of a random bytes generator.

14. The method of claim 12, wherein the asymmetric encryption operation utilizes the NTRU (nth degree truncated polynomial ring) encryption protocol modified by increasing the sizes of the public key and private key.

15. The method of claim 12, wherein the JavaScript library is packaged in a docker container.

16. The method of claim 15, wherein instructions within the docker container instruct the first device to install Linux in a virtual environment and compile source code of the asymmetric encryption operation into JavaScript.

17. The method of claim 16, wherein the JavaScript library is stored into a shared file directory that is shared between the docker container and the host system of the first device.
